(19) United States
(12) Patent Application Publication
(10) Pub. No.: US 2025/0218033 A1
(43) Pub. Date: Jul. 3, 2025

(54) POLARIMETRIC SCLERAL POSITION SENSING FOR EYE TRACKING SENSOR

(71) Applicant: Meta Platforms Technologies, LLC, Menlo Park, CA (US)

(72) Inventor: Mantas Zurauskas, Redmond, WA (US)

(21) Appl. No.: 18/999,667

(22) Filed: Dec. 23, 2024

Related U.S. Application Data
(60) Provisional application No. 63/615,701, filed on Dec. 28, 2023.

(51) Int. Cl. G06T 7/73; G06V 10/145; G06V 10/774; G06V 40/18

(52) U.S. Cl. CPC G06T 7/73; G06V 10/145; G06V 10/774; G06V 40/193; G06T 2207/30196

(57) ABSTRACT

The subject disclosure provides for systems and methods for eye tracking in a mixed reality environment. The method may include emitting a light source at an eye of the user. The method may include capturing light propagation of the light source with an image capturing device oriented in proximity to the eye of the user, wherein at least one of the light source of the image capturing device comprises a polarization element. The method may include identifying at least one textured region of the sclera based on the light propagation captured by the image capturing device. The method may include, in response to identifying the at least one textured region of the sclera, generating a representation of the eye. The method may include determining a gaze direction of the eye based on the representation of the eye.

### CROSS RELATED APPLICATIONS

The present disclosure is related and claims priority under 35 U.S.C. 119(e) to U.S. Provisional Patent Application No. 63/615,701 filed on Dec. 28, 2023, the disclosure of which is hereby incorporated by reference in its entirety for all purposes.

### TECHNICAL FIELD

The present disclosure generally relates to generating eye models, and more particularly to a biometric eye scanner with wearable form factor.

### BACKGROUND

Eye tracking with a single off-axis imaging sensor is challenging because the pupil is not clearly visible at all gaze angles. Current state of the art solutions rely on using multiple cameras situated around the frame of an Mixed Reality device. Alternatively, a single camera is used while performance of the eye tracking system is reduced by restricting trackable range of eye states.

### SUMMARY

The subject disclosure provides for systems and methods for generating dense depth maps. One aspect of the present disclosure relates to a method in a mixed reality environment. The method may include emitting a light source at an eye of the user. The method may include capturing light propagation of the light source with an image capturing device oriented in proximity to the eye of the user, wherein at least one of the light source of the image capturing device comprises a polarization element. The method may include identifying at least one textured region of the sclera based on the light propagation captured by the image capturing device. The method may include in response to identifying the at least one textured region of the sclera, generating a representation of the eye. The method may include determining a gaze direction of the eye based on the representation of the eye.

One aspect of the present disclosure relates to a system for generating dense depth maps. The system may include one or more hardware processors configured by machine-readable instructions. The processor(s) may be configured to emit a light source at an eye of the user. The method may include emitting a light source at an eye of the user. The processor(s) may be configured to capture light propagation of the light source with an image capturing device oriented in proximity to the eye of the user, wherein at least one of the light source of the image capturing device comprises a polarization element. The processor(s) may be configured to identify at least one textured region of the sclera based on the light propagation captured by the image capturing device. The processor(s) may be configured to, in response to identifying the at least one textured region of the sclera, generate a representation of the eye. The processor(s) may be configured to determine a gaze direction of the eye based on the representation of the eye.

Yet another aspect of the present disclosure relates to a non-transient computer-readable storage medium having instructions embodied thereon, the instructions being executable by one or more processors to perform a method for eye tracking in a mixed reality environment. The method may include emitting a light source at an eye of the user. The method may include capturing light propagation of the light source with an image capturing device oriented in proximity to the eye of the user, wherein at least one of the light source of the image capturing device comprises a polarization element. The method may include identifying at least one textured region of the sclera based on the light propagation captured by the image capturing device. The method may include in response to identifying the at least one textured region of the sclera, generating a representation of the eye. The method may include determining a gaze direction of the eye based on the representation of the eye.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system platform for generating an eye model.

FIG. 2 illustrates an alternative system platform for generating an eye model.

FIG. 3 illustrates an alternative system platform for generating an eye model.

FIG. 4 illustrates an alternative system platform for generating an eye model.

FIG. 5 illustrates a system configured for generating an eye model, in accordance with one or more implementations.

FIG. 6 illustrates a method for generating an eye model, in accordance with one or more implementations.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

The system and method comprise using polarimetric sensors to capture otherwise invisible sub-surface features of sclera in addition to a standard image of an eye. The polarimetric feature map is then used to supplement a pupil tracking algorithm to ensure that the pupil position and gaze angle can be measured even when the pupil is not directly visible to an eye tracking (ET) sensor. The sensing capability can be introduced to all camera-based ET systems by adding a polarized filter layer to eye tracking cameras in both AR and VR devices. The scleral tracking functionality improves industrial design restrictions by permitting placing ET cameras at less conspicuous locations.

An aspect of the disclosure is the use of the light propagation properties when placing a light source in proximity to the sclera region of the eye. In particular, the collagen fibers in the sclera region of the eye affects the light through sub-surface scattering. The light scattering can be received by image capture devices, wherein the image capture devices comprise polarized pixels. Polarization contrast provides a new set of features that complement intensity information. The intensity information can be correlated to regions of the eye such that the pupil can be identified. The intensity of the received light scattering can be determined based on the angle of polarization for the light receiving medium.

The impact and utilization of the polarization effect comprises vectorization of the light scattering in an eye tracking model. In particular, the vectorization comprises determining stokes parameters. Stokes parameters are a set of values that describe the polarization state of electromagnetic radiation. The determination of the light scattering properties changes a seemingly random scattering of light during propagation in proximity to the sclera to a representative model of eye movement during the use of a mixed reality headset.

For example, the following formulas comprise a representation of determining the Stokes parameters:

$$Stokes parameters {S}_{0} , {S}_{1} , {S}_{2} can be computed from the raw data :$$

$${S}_{0} = {I}_{0} + {I}_{45} + {I}_{90} + {I}_{135}$$

$${S}_{1} = {I}_{0} - {I}_{90}$$

$${S}_{2} = {I}_{45} - {I}_{135}$$

$$Intensity ( I ) , Angle of Linear Polarization ( AoLP ) and \\ Degree of Linear Polarization ( DoLP ) can be computed as$$

$$I = {S}_{0}$$

$$DoLP = \frac{\sqrt{{S}_{1}^{2} + {S}_{2}^{2}}}{{S}_{0}}$$

$$AoLP = \frac{1}{2} arctan \frac{{S}_{1}}{{S}_{2}} ,$$

wherein the I₀, I₄₅, I₉₀, and I₁₃₅ represent the measure light intensity received at image capture sensors whose pixels are polarized at 0, 45, 90 and 135 degrees, respectively. Further, the responses to the scattering can be trackable. Further, the system can identify spatial coordinates from a modeled representation of the eye. These spatial coordinates can be tracked and used to make a representative determination of the movement of the user's eye.

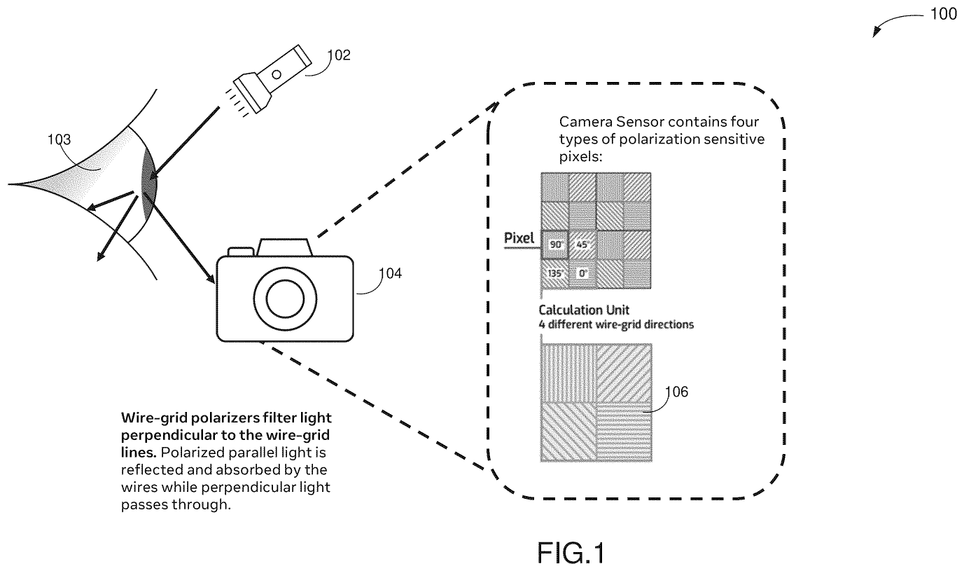

As shown in FIG. 1, the system 100 can include a VR/AR headset. The VR/AR headset can comprise a visual image generator (not shown) that provides images to the user in the headset. The system can comprise a light source 102. In one aspect, the light source is an LED. In a further aspect, the LED can comprise polarized light. Structurally, the light source 102 can be polarized by an internal structure or by a physical attachment such as a polarized grid 106 that can filter certain frequencies and/or propagation patterns of light. For example, the polarized grid can be oriented at 0, 45, 90, and 135 degrees. In alternative embodiments, the polarized grid 106 can be oriented at other angles such as 15, 25, 75, 115, and the like. The LED light source 102 can be positioned to emit towards the eye of the user, in particular the sclera 103 region of the eye. The light scattering from the sclera can be received at an image capturing device 104. For example, the light capturing device 104 can comprise a polarization camera. In a further aspect, the polarization camera 104 can capture the intensity of polarized light on the pixels of the light capturing device and can be used to determine the stokes parameters. The stokes parameters can be used to determine a model and track the movement of the eye. In another embodiment, the system can comprise an image capturing sensor wherein the sensor is a point scanning sensor. Further, the point scanning sensor can be coupled to a micro-electromechanical system MEMs or a liquid crystal device-based scanner.

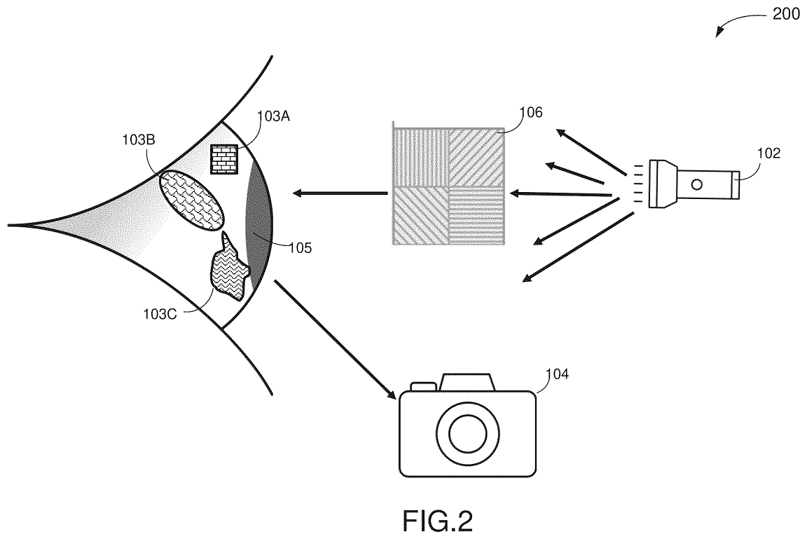

The disclosure can function by using the polarized light signatures reflected from the sclera 103 to further augment an estimation of the user's pupil 105 during an eye tracking exercise. The use of the estimation model may be necessary in the event the cameras tracking the user eye movement may be located at the side of the eye, which may inhibit a direct view of the movement of the pupil. As depicted in FIGS. 2-4, the sclera can have regions of varying texture (e.g., 103A, 103B, 103C). The textured region of the sclera is a product of the varying layer arrangements of collagen fibers and elastin. These variations of the collagen arrangements can define distinct surface regions of the sclera that may be identified by polarized light. Projecting polarized light and capturing the polarized image of the distinct surface regions can provide a model of a topographic-type map of the eye surface. This modeled surface of the eye can be provided as an input to estimate the location of the pupil, wherein the estimated location of the pupil can be used to estimate the gaze angle of the user. Subsequent movement of the eye can yield an altered depiction of the modeled surface, thus changing the input to estimate the changed location of the pupil, resulting in a change of the estimated gaze angle.

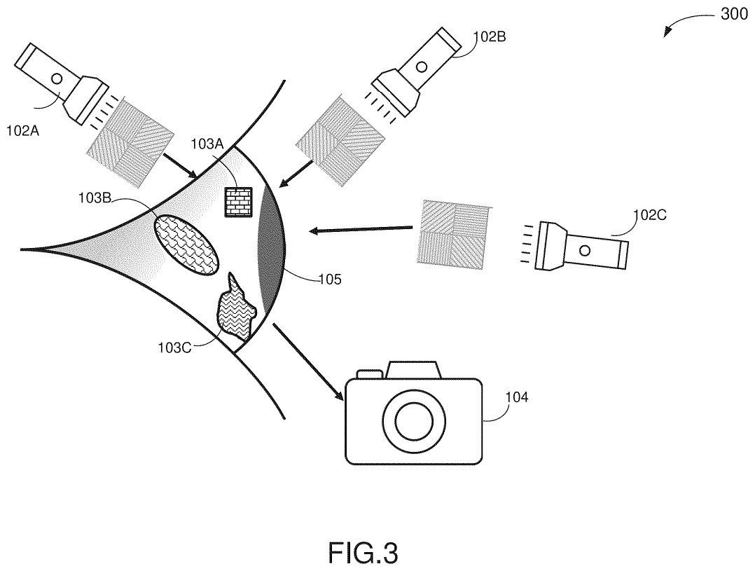

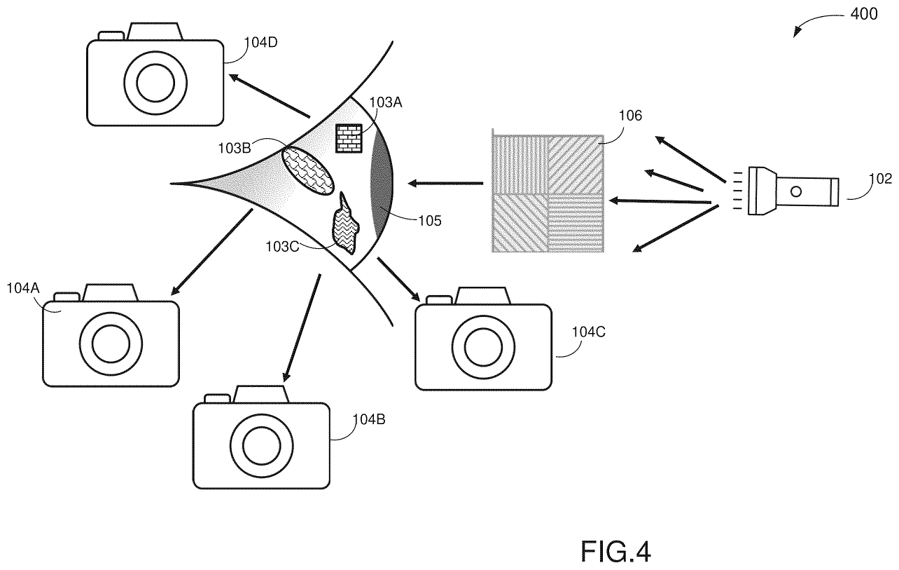

In a second embodiment, as depicted in FIG. 2, the system 200 can comprise a single camera 104 and a single light source 102. In a further aspect, the camera 104 can comprise a linear polarized filter 106 positioned in front of the camera or in front of the light source 102 to transmit polarized light to the sclera. In yet another embodiment, the system 300, as depicted in FIG. 3, can comprise a plurality of light sources 102A, 102B, and 102C. The light sources 102A-C can be arranged in proximity to the eye of the user. Further, the light sources can comprise varying polarization states, wherein the polarization grid attachment 106 is oriented at a different angle for the light sources. In another embodiment, depicted in FIG. 4, the system 400 can comprise four cameras 104A-D, wherein the cameras can comprise a polarization grid oriented at a grid angle of 0 degrees for a first camera 104A, a second camera 104B being oriented at a grid angle of 45 degrees, a third camera 104C being oriented at a grid angle of 90 degrees and a fourth camera 104D being oriented at a grid angle of 135 degrees. In other aspects, the cameras can have the same polarization, not requiring all the cameras to apply the same angle of polarization. A fourth embodiment can comprise a configuration combining the elements from FIG. 3 and FIG. 4, wherein there is a plurality of light sources and a plurality of image capturing devices.

In a further aspect, each light source 102 can be configured to be controlled by a processor configured to activate the cluster of light sources in a sequence to achieve different polarization states of light for the image capture devices. In another aspect, the sequence generated by the processor can be executed at varying speeds to generate a plurality of light propagation configurations at the image capture devices. In a yet a further aspect, the light source 102 in any of the embodiments depicted in FIGS. 1-4 can comprise a rapid polarization switching feature, wherein the angle of polarization emitted by the light source can switch such that the orientation of the polarization for the filter is dynamic instead of being static. The embodiments depicted in FIGS. 1-4 can also include an ambient light compensation. To maintain consistent tracking performance across varying lighting conditions, the respective systems can incorporate sensors that detect ambient light levels. These sensors adjust the intensity and polarization of the emitted light, accordingly, ensuring that the eye-tracking system functions effectively in both bright and dim environments. This feature enhances the robustness of the system, making it suitable for use in diverse settings.

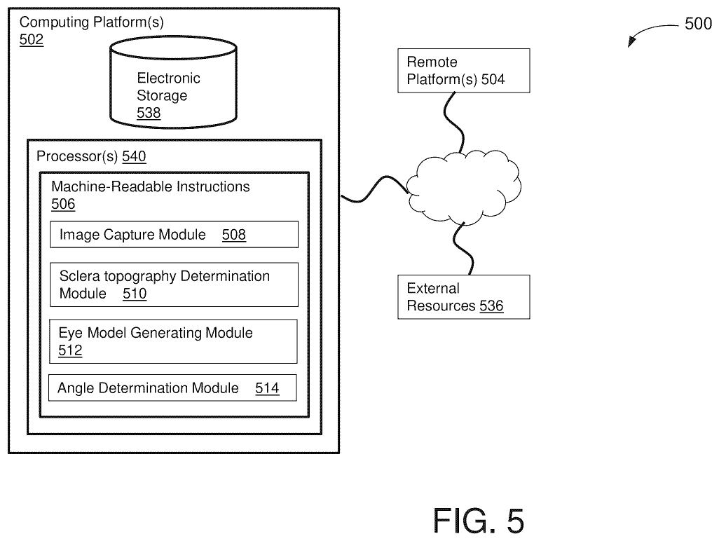

FIG. 5 illustrates a system 500 configured for generating an eye model, in accordance with one or more implementations. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of image capture module 508, sclera topography determination module 510, eye model generating module 512, and angle calculation determination module 514.

Image capture module 508 may be configured to capture biometric information based on the scanning. The biometric information can comprise pupil location, pupil size (included dilated and normal), sclera area. The two-dimensional data received from the camera devices can be extrapolated to generate a model of the eye in the eye model generating module 512. The biometric information may be stored online.

Sclera topography determination module 510 may be configured to determine sclera topography based on the biometric information and/or image capture data. For example, the various distinct regions 103A-C of the sclera can comprise differing textures and be identified via the polarized imagery received at the cameras.

Eye model generating module 512 may be configured to generate an eye model based on the polarized sclera topography. The eye model may be used for eye tracking. For example, the distinct region generated by the sclera topography determination module 512 can be tracked. For example, after an eye movement, the distinct region may move indicating a movement of the eye. The respective change in shape of the distinct region determined and infer the change in gaze direction of the eye. In a further aspect, the eye model generating module 512 can comprise a machine learning model that is repetitively updated based on the image data. Training the machine learning model can comprise receiving biometric data into a neural network. The model can be further trained to model gaze response in the event of squinting, sensor slippage and excessive blinking. In a further aspect, the model can include salience maps of the eye. The salience maps can highlight regions that provide the most influence on the model's prediction. For example, the salience maps can use both eye and surrounding skin for making predictions, while polarization-enhanced models are more reliant on the eye surfaces.

Angle calculation determination module 514 may be configured to determine gaze angle calculations based on the resultant output of the eye model generation module. In a further aspect, the system can comprise configurations with multiple light sources and/or multiple image capture devices wherein the module can determine the angle of propagation of the reflection from the sclera.

In some implementations, computing platform(s) 502, remote platform(s) 504, and/or external resources 536 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 536 may be operatively linked via some other communication media.

A given remote platform 504 may include one or more processors configured to execute computer program modules. The computer program modules may be configured to enable an expert or user associated with the given remote platform 504 to interface with system 500 and/or external resources 536, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 536 may include sources of information outside of system 500, external entities participating with system 500, and/or other resources. In some implementations, some or all of the functionality attributed herein to external resources 536 may be provided by resources included in system 500.

Computing platform(s) 502 may include electronic storage 538, one or more processors 540, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 538 may comprise non-transitory storage media that electronically stores information. The electronic storage media of electronic storage 538 may include one or both of system storage that is provided integrally (i.e., substantially non-removable) with computing platform(s) 502 and/or removable storage that is removably connectable to computing platform(s) 502 via, for example, a port (e.g., a USB port, a fire wire port, etc.) or a drive (e.g., a disk drive, etc.). Electronic storage 538 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 538 may include one or more virtual storage resources (e.g., cloud storage, a virtual private network, and/or other virtual storage resources). Electronic storage 538 may store software algorithms, information determined by processor(s) 540, information received from computing platform(s) 502, information received from remote platform(s) 504, and/or other information that enables computing platform(s) 502 to function as described herein.

Processor(s) 540 may be configured to provide information processing capabilities in computing platform(s) 502. As such, processor(s) 540 may include one or more of a digital processor, an analog processor, a digital circuit designed to process information, an analog circuit designed to process information, a state machine, and/or other mechanisms for electronically processing information. Although processor(s) 540 is shown in FIG. 5 as a single entity, this is for illustrative purposes only. In some implementations, processor(s) 540 may include a plurality of processing units. These processing units may be physically located within the same device, or processor(s) 540 may represent processing functionality of a plurality of devices operating in coordination. Processor(s) 540 may be configured to execute modules 508, 510, 512, 514 and/or other modules. Processor(s) 540 may be configured to execute modules 508, 510, 512, 514 and/or other modules by software; hardware; firmware; some combination of software, hardware, and/or firmware; and/or other mechanisms for configuring processing capabilities on processor(s) 540. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, and/or 514 are illustrated in FIG. 5 as being implemented within a single processing unit, in implementations in which processor(s) 540 includes multiple processing units, one or more of modules 508, 510, 512, and/or 514 may be implemented remotely from the other modules. The description of the functionality provided by the different modules 508, 510, 512, and/or 514 and described below is for illustrative purposes, and is not intended to be limiting, as any of modules 508, 510, 512, and/or 514 may provide more or less functionality than is described. For example, one or more of modules 508, 510, 512, and/or 514 may be eliminated, and some or all of its functionality may be provided by other ones of modules 508, 510, 512, and/or 514. As another example, processor(s) 540 may be configured to execute one or more additional modules that may perform some or all of the functionality attributed below to one of modules 508, 510, 512, and/or 514.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

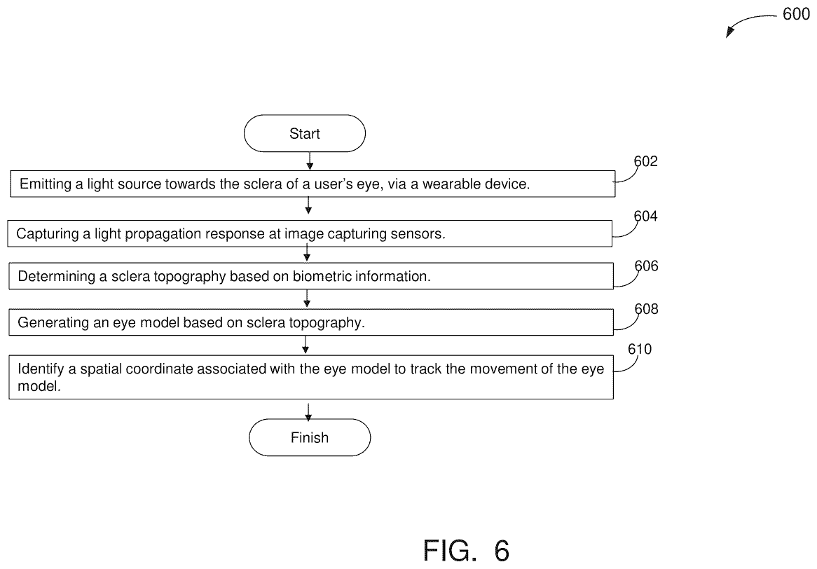

FIG. 6 is an example flow diagram (e.g., process 600) for a biometric eye scanner with wearable form factor, according to certain aspects of the disclosure. For explanatory purposes, the example process 600 is described herein with reference to FIG. 5. Further for explanatory purposes, the steps of the example process 600 are described herein as occurring in serial, or linearly. However, multiple instances of the example process 600 may occur in parallel. For purposes of explanation of the subject technology, the process 600 will be discussed in reference to FIG. 5.

At step 602, the process 600 may include emitting a light source towards the sclera of a user's eye, via a wearable device. At step 604, the process 600 may include capturing a light propagation response at image capturing sensors. At step 606, the process 600 may include determining a sclera topography based on the biometric information. At step 608, the process 600 may include generating an eye model based on the polarized sclera topography. At step 610, the process 600 may identify a spatial coordinate associated with the eye model and track the movement of the eye model.

For example, as described above in relation to FIG. 5, at step 602, the process 600 may include emitting a light source toward the sclera of a user's eye via a wearable device. At step 604, the process 600 may include capturing light propagation based on the scanning, through the image capture module 508. At step 606, the process 600 may include identifying at least one textured region of the sclera based on the light propagation captured by the image capturing device, through sclera topography determination module 510. At step 608, the process 600 may include generating an eye model based on sclera topography, in response to identifying the at least one textured region of the sclera, through eye model generating module 510. At step 610, the process may include determining a gaze direction of the eye based on the representation of the eye.

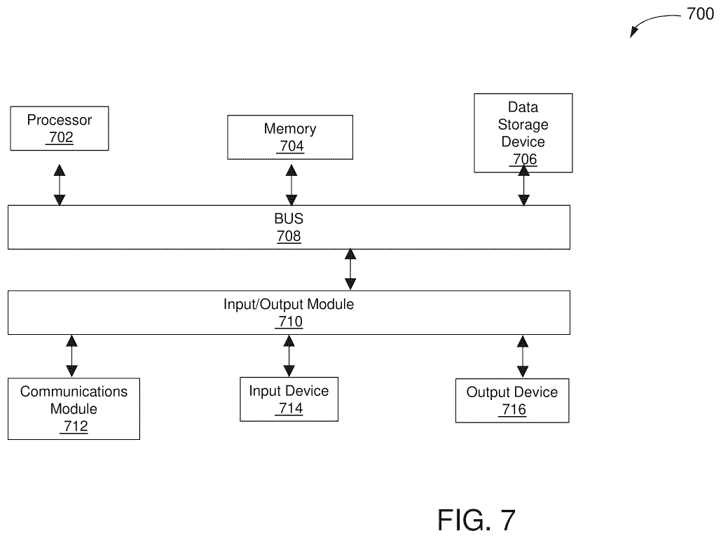

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middle ware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The user computing system 700 reads sensor data information that may be read from the data and stored in a memory device, such as the memory 704. Additionally, data from the memory 704 servers accessed via a network the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method for eye tracking in a mixed reality headset, the method comprising:
emitting a light source at an eye of a user;
capturing light propagation of the light source with an image capturing device oriented in proximity to the eye of the user, wherein at least one of the light source of the image capturing device comprises a polarization element;
identifying at least one textured region of the sclera based on the light propagation captured by the image capturing device;
in response to identifying the at least one textured region of the sclera, generating a representation of the eye; and
determining a gaze direction of the eye based on the representation of the eye.

2. The method of claim 1, further comprising tracking a spatial coordinate associated with the at least one textured region and determining a change in the spatial coordinate.

3. The method of claim 2, further comprising, in response to determining a change in the spatial coordinate, adjusting the representation of the eye.

4. The method of claim 1, further comprising receiving image data from a plurality of image capturing devices, wherein at least one image capturing device of the plurality of image capturing devices is configured with a polarization angle that differs from another image capturing device of the plurality of image capturing devices.

5. The method of claim 1, further comprising emitting light toward the eye of the user from a plurality of light sources.

6. The method of claim 1, wherein generating a representation of the eye comprises training a machine learning model to estimate a location of a user's pupil.

7. The method of claim 2, wherein the light source comprising polarized light is generated by a polarized grid such that the polarized grid is oriented at approximately one of: 0 degrees, 45 degrees, 90 degrees or 135 degrees.

8. A system for eye tracking in a mixed reality headset:
a headset comprising:
a light source;
an image capturing device comprising a polarized filter; and
one or more hardware processors configured by machine-readable instructions to: emit a light source at an eye of a user;
capture light propagation of the light source with an image capturing device oriented in proximity to the eye of the user, wherein at least one of the light source of the image capturing device comprises a polarization element;
identify at least one textured region of the sclera based on the light propagation captured by the image capturing device;
in response to identifying the at least one textured region of the sclera, generate a representation of the eye; and
determine a gaze direction of the eye based on the representation of the eye.

9. The system of claim 8, where the light source comprises linearly polarized light, wherein the light source comprises a polarized filter oriented at a grid angle.

10. The system of claim 8, further comprising a point scanning sensor and at least one of a micro-electromechanical system (MEMs) or liquid crystal device-based scanner.

11. The system of claim 9, wherein the light source can comprise a polarization alternation feature, wherein the light source switches the grid angle.

12. The system of claim 8, wherein the light source comprising polarized light is generated by a polarized grid such that the polarized grid is oriented at approximately one of: 0 degrees, 45 degrees, 90 degrees or 135 degrees.

13. The system of claim 8, further comprising a plurality of light sources wherein each light source of the plurality of light sources is configured to switch an angle of polarization associated with the light source.

14. A non-transient computer-readable storage medium having instructions embodied thereon, the instructions being executable by one or more processors to perform a method for eye tracking in a mixed reality headset g, the method comprising:
emitting a light source at an eye of a user;
capturing light propagation of the light source with an image capturing device oriented in proximity to the eye of the user, wherein at least one of the light source of the image capturing device comprises a polarization element;
identifying at least one textured region of the sclera based on the light propagation captured by the image capturing device;
in response to identifying the at least one textured region of the sclera, generating a representation of the eye; and
determining a gaze direction of the eye based on the representation of the eye.

15. The non-transient computer-readable storage medium of claim 14, further comprising tracking a spatial coordinate associated with the at least one textured region and determining a change in the spatial coordinate.

16. The non-transient computer-readable storage medium of claim 15, further comprising, in response to determining a change in the spatial coordinate, adjusting the representation of the eye.

17. The non-transient computer-readable storage medium of claim 14, further comprising receiving image data from a plurality of image capturing devices, wherein at least one image capturing device of the plurality of image capturing devices is configured with a polarization angle that differs from another image capturing device of the plurality of image capturing devices.

18. The non-transient computer-readable storage medium of claim 14, further comprising emitting light toward the eye of the user from a plurality of light sources.

19. The non-transient computer-readable storage medium of claim 14, wherein generating a representation of the eye comprises training a machine learning model to estimate a location of a user's pupil.

20. The non-transient computer-readable storage medium of claim 15, wherein the light source comprising polarized light is generated by a polarized grid such that the polarized grid is oriented at approximately one of: 0 degrees, 45 degrees, 90 degrees or 135 degrees.
